(19) United States
(12) Patent Application Publication
(10) Pub. No.: US 2006/0253569 A1
(43) Pub. Date: Nov. 9, 2006

(54) Administrative information management method of storage network, storage management system and computer program product

(76) Inventors: Kenji Tamura, Odawara (JP); Akihiro Okazaki, Miura (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/166,075

(22) Filed: Jun. 27, 2005

(30) Foreign Application Priority Data
May 6, 2005 (JP) 2005-134881

(51) Int. Cl. G06F 15/173

(52) U.S. Cl. 709/224

(57) ABSTRACT

In a storage network, a number of host computers or management servers storage subsystem are connected, via a management LAN, to a management terminal that manages a storage subsystem and which is connected to a management center via a remote maintenance line. The host computer or management server transmits administrative information to the management terminal via the management LAN. The management terminal transmits the administrative information acquired from the host computer or management server to the management center via the remote maintenance line.

### CROSS-REFERENCES TO RELATED APPLICATIONS

This application relates to and claims priority from Japanese Patent Application No. 2005-134881, filed on May 6, 2005, the entire disclosure of which is incorporated herein by reference.

### BACKGROUND OF THE INVENTION

1. Field of the Invention

The present invention relates to an administrative information management method of a storage network, storage management system and computer program product.

2. Description of the Related Art

In recent years, a disk array device or the like has been used as a storage subsystem for managing large volumes of data. A disk array device is configured by arranging a plurality of memory devices in an array and, for instance, provides a memory area based on RAID (Redundant Arrays of Independent Disks). Lately, pursuant to the diffusion of a SAN (Storage Area Network) environment, the integration of storage subsystems is being rapidly advanced. In a SAN environment, a plurality of storage subsystems is connected to a plurality of host computers via a high-speed FC (Fibre Channel) switch, and operation and maintenance control such as the easy management of the SAN configuration, early failure detection and prompt handling thereof, and establishment of security based on appropriate access control are being sought after. Storage management software for managing a storage network is loaded onto, for instance, a host computer or a dedicated management server. For example, Japanese Patent Laid-Open Publication No. H11-167504 proposes remote maintenance technology of a server.

### SUMMARY OF THE INVENTION

Meanwhile, conventionally, when a failure occurs in a storage network, a support engineer is sent to the local site to analyze the cause of failure and collect failure information. Nevertheless, when the location of failure is in a remote place such as in a foreign country, the prompt handling of such failure is difficult. Further, when a remote maintenance line for connecting the host computer and the management center is newly laid down for promptly analyzing the cause of failure at remote locations, this will result in spiraling costs. Moreover, there are cases where the laying of such remote maintenance line is not desirable to the clients from the perspective of security.

Thus, an object of the present invention is to propose technology for performing remote maintenance to a storage network without having to lay down a new remote maintenance line.

With the storage network to which the present invention is employed, a plurality of host computers or a management server is connected, via a management communication line, to a management terminal that manages a storage subsystem and which is connected to a management center via a remote maintenance line.

The administrative information management method of a storage network according to the present invention includes a step of transmitting the administrative information of the host computer or the management server to the management terminal via the management communication line; and a step of transmitting the administrative information acquired by the management terminal from the host computer or the management server to the management center via the remote maintenance line. Since the management communication line has been conventionally used as a maintenance line for connecting the plurality of host computers, management server and management terminal, it is possible to perform remote maintenance to the storage network without having to lay down a new line. Here, administrative information includes, for instance, failure information, configuration information, operation information, performance information and so on of the storage network.

The management server, for example, consolidates the administrative information of a plurality of host computers, and transmits such administrative information to the management terminal via the management communication line. As a result, since the management of administrative information can be unified, even in cases where the bandwidth of the remote maintenance line is small, for instance, failure information that is useful in analyzing the failure can be extracted and transmitted to the management terminal.

The computer program product according to the present invention includes a storage management software. The storage management software causes a host computer or a management server execute a step for transmitting administrative information of the host computer or the management server to a management terminal via a management communication line. This storage management software, for instance, may be installed in the host computer or management server, or may be stored in a recording medium. As such recording medium, for example, the likes of an optical recording medium (a recording medium capable of optically reading data such as a CD-RAM, CD-ROM, DVD-RW, DVD-ROM, DVD-R, PD, MD or MO), a magnetic recording medium (a recording medium capable of magnetically reading data such as a flexible disk, magnetic card or magnetic tape) or a memory element (a semiconductor memory element such as a DRAM or a ferroelectric memory element such as an FRAM) may be used.

According to the present invention, remote maintenance can be performed to a storage network without having to lay down a new remote maintenance line.

### BRIEF DESCRIPTION OF THE DRAWINGS

FIG. 1 is a schematic configuration of the storage management system according to the present embodiment;

FIG. 2 is a system configuration centered around the storage subsystem;

FIG. 3 is a system configuration of the host computer;

FIG. 4 is a system configuration of the management terminal;

FIG. 5 is a system configuration of the management server;

FIG. 6 is an explanatory diagram of the processing for collecting failure information;

FIG. 7 is an explanatory diagram of the processing for collecting failure information;

FIG. 8 is an explanatory diagram of the processing for collecting configuration information and the like;

FIG. 9 is an explanatory diagram of the processing (push type) for collecting failure information;

FIG. 10 is an explanatory diagram of the processing (pull type) for collecting failure information;

FIG. 11 is an explanatory diagram of the processing (push type) for collecting failure information;

FIG. 12 is an explanatory diagram of the processing (pull type) for collecting failure information; and

FIG. 13 is an explanatory diagram of the processing (push type) for collecting failure information.

### DETAILED DESCRIPTION OF THE PREFERRED EMBODIMENTS

Embodiments of the present invention are now explained with reference to the respective drawings.

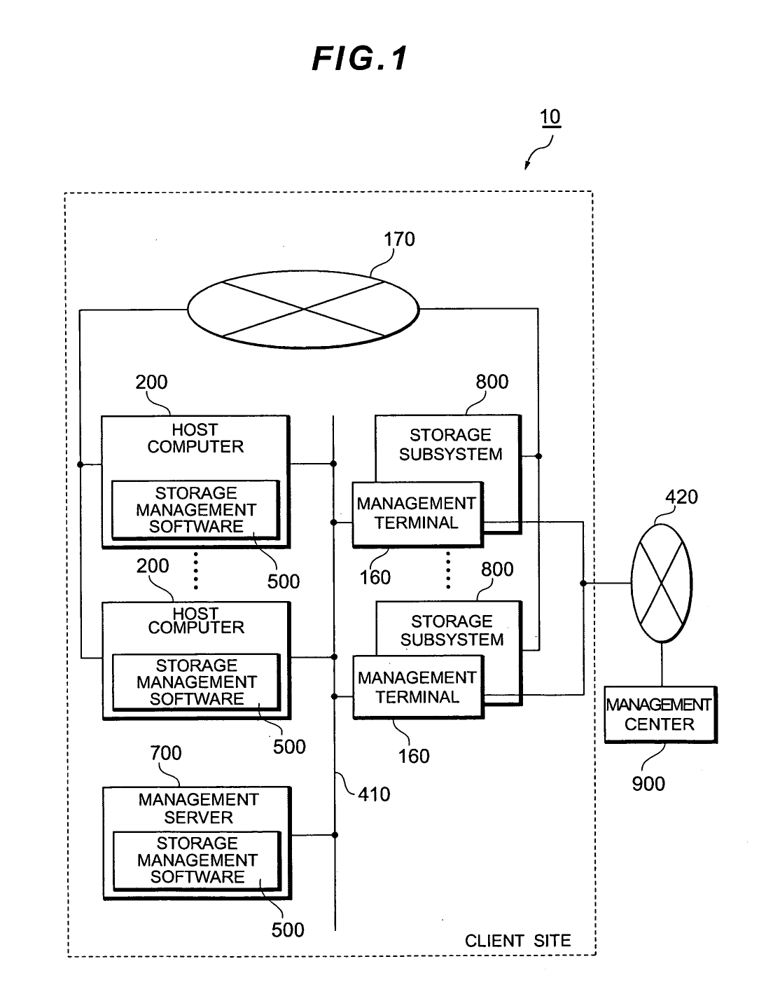

FIG. 1 is a diagram showing the schematic configuration of a storage management system 10 according to the present embodiment. The storage management system 10 is a system having a function of monitoring the occurrence of failures in a storage network (storage subsystem (storage system) 800, communication network 170 or other network components), and transmitting failure information in the case of such failure to a management center 900. The storage management system 10 also manages the performance of a storage subsystem 800 and a host computer 200, and manages the configuration information of the storage subsystem 800. The storage management system 10 is primarily equipped with storage management software (storage management program) 500, a management LAN (management communication line) 410 and a management terminal 160. The storage management software 500, for instance, is loaded onto the host computer 200 or a management server 700.

The host computer 200, for example, is a business computer of an ATM system of banks or a seat reservation system of airlines, and is specifically a personal computer, workstation, mainframe computer or the like. The storage subsystem 800 provides a storage resource to the host computer 200. The data I/O request from the host computer 200 to the storage subsystem 800 is conducted via a communication network 170. Each of the storage subsystems 800 is equipped with a management terminal 160. The host computer 200, management server 700 and management terminal 160 are mutually connected via a management LAN (internal LAN) 410. Further, the management terminal 160 is connected to the management center via a remote maintenance line 420. Incidentally, there may be one or a plurality of host computers 200, management servers 700 and storage subsystems 800, respectively.

The management center 900 is a facility for managing the storage subsystem 800, communication network 170 and the like. A support engineer is standing by at the management center 900, and he/she collects the failure information sent from the storage management system 10 and analyzes such failure. As the remote maintenance line 420, for instance, the likes of an Internet line or telephone line may be used.

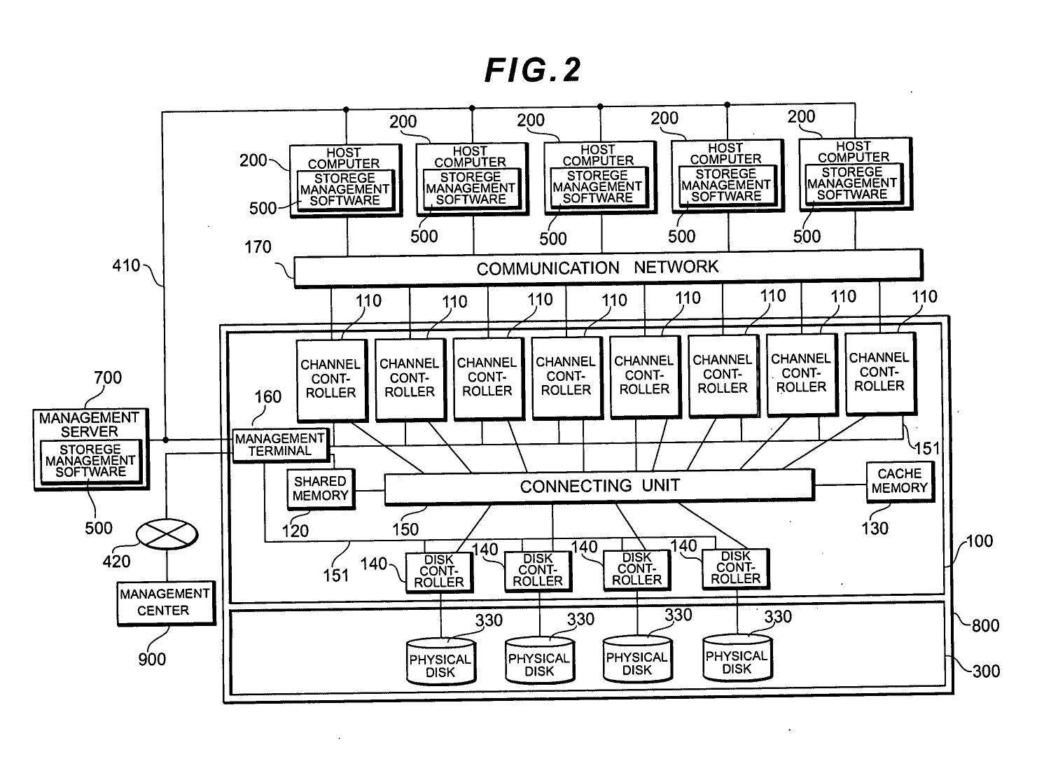

FIG. 2 is a diagram showing the system configuration centered around the storage subsystem 800. For the convenience of explanation, a single storage subsystem 800 is explained. The storage subsystem 800 is primarily configured from a disk controller 100 and a memory device 300. The disk controller 100, for example, controls the input and output of data to and from the memory device 300 according to a command received from the host computer 200. Further, the disk controller 100, for instance, performs various processing such as the setting or changing of configuration information of the storage subsystem according to a command received from the management server 700.

The host computer 200 is communicably connected to the disk controller 100 via the communication network 170. As the communication network 170, for example, when a SAN (Storage Area Network) is used, data I/O processing is performed in block units between the host computer 200 and memory device 300. The communication protocol performed between the host computer 200 and disk controller 100 via the SAN, for instance, is a fibre channel protocol.

Needless to say, the host computer 200 and disk controller 100 do not have to be connected via a SAN, and, for example, may be connected via a LAN (Local Area Network), or may be connected directly without going through any network. When the host computer 200 and disk controller 100 are to be connected via the LAN, for instance, communication may be conducted according to TCP/IP (Transmission Control Protocol/Internet Protocol). When the host computer 200 and disk controller 100 are to be connected directly without going through any network, for example, communication may be conducted according to a communication protocol such as FICON (Fibre Connection) (registered trademark), ESCON (Enterprise System Connection) (registered trademark), ACONARC (Advanced Connection Architecture) (registered trademark), FIBARC (Fibre Connection Architecture) (registered trademark) or the like.

The management server 700 is connected to the management terminal 160 via the management LAN 410. The management LAN 410, for instance, is configured from the Internet, a dedicated line or the like. Communication between the management server 700 and management terminal 160 to be conducted via the management LAN 410, for example, is based on a communication protocol such as TCP/IP.

The memory device 300 has a plurality of physical disk drives 330. The physical disk drive 330, for instance, is a hard disk drive such as an ATA (Advanced Technology Attachment) disk drive, SCSI (Small Computer System Interface) disk drive or fibre channel disk drive. It is also possible to configure RAID (Redundant Arrays of Inexpensive Disks) with a plurality of disk drives arranged in an array. Further, LDEV (Logical Device), which is a logical memory area, may also be set in a physical volume, which is a physical memory area provided from the physical disk drive 330.

The disk controller 100 and memory device 300 may be connected directly without going through any network, or connected via a network. Or the memory device 300 and disk controller 100 may be configured integrally.

The disk controller 100 has a plurality of channel controllers 110, a shared memory 120, a cache memory 130, a plurality of disk controllers 140, a management terminal 160 and a connecting unit 150.

The disk controller 100 communicates with the host computer 200 based on the communication control of the channel controller 110. The channel controller 110 has a communication interface for communicating with the host computer 200, and has a function for transferring a data I/O command and the like with the host computer 200. Each of the channel controllers 110 is connected, together with the management terminal 160, via an internal LAN (shared bus) 151. As a result, a micro program or the like to be executed by the channel controller 110 can be installed from the management terminal 160.

The connecting unit 150 mutually connects the channel controller 110, shared memory 120, cache memory 130, disk controller 140 and management terminal 160. The transfer of data and commands among the channel controller 110, shared memory 120, cache memory 130, disk controller 140 and management terminal 160 is conducted via the connecting unit 150. The connecting unit 150, for example, is configured from a crossbar switch or the like.

The shared memory 120 and cache memory 130 are memory devices to be shared respectively by the channel controller 110 and disk controller 140. The shared memory 120 is primarily used for storing configuration information and the like of the storage subsystem 800. The cache memory 130 is primarily used for temporarily storing data to be read from and written into the physical disk 330.

For instance, when the data I/O request that a certain channel controller 110 received from the host computer 200 is a write command, such channel controller 110 writes the write command into the shared memory 120, and writes the write data received from the host computer 200 into the cache memory 130. Meanwhile, the disk controller 140 constantly monitors the shared memory 120, and, when the disk controller 140 detects that a write command has been written into the shared memory 120, it reads the dirty data from the cache memory 130 according to such write command and then destages this onto the physical disk drive 300.

Further, when the data I/O request that a certain channel controller 110 received from the host computer 200 is a read command, such channel controller 110 checks whether data subject to be read exists in the cache memory 130. Here, when data subject to be read exists in the cache memory 130, the channel controller 110 reads this data from the cache memory 130, and transmits this to the host computer 200. Meanwhile, when the data subject to be read does not exist in the cache memory 130, the channel controller 110 writes the read command in the shared memory 120. The disk controller 140 is constantly monitoring the shared memory 120, and when it detects that a read command has been written into the shared memory 120, the disk controller 140 reads data subject to be read from the memory device 300 and writes this into the cache memory 130, and writes into the shared memory 120 to the effect that it wrote the data subject to be read into the cache memory 130. Then, channel controller 110 detects that the data subject to be read has been written into the cache memory 130, reads such data from the cache memory 130, and transmits this to the host computer 200.

As described above, the transfer of data is conducted between the channel controller 110 and disk controller 140 via the cache memory 130. Among the data stored in the physical disk drive 330, data to be read or written by the channel controller 110 or disk controller 140 is temporarily written into the cache memory 130.

Incidentally, in addition to the configuration of indirectly giving instructions of writing or reading data from the channel controller 110 to the disk controller 140 with the shared memory 120 intervening therebetween, for instance, a configuration of directly giving instructions of writing or reading data from the channel controller 110 to the disk controller 140 without going through the shared memory 120 may also be employed. Or, it is also possible to control the I/O of data by providing the channel controller 110 with the function of the disk controller 140.

The disk controller 140 is communicably connected to a plurality of physical disk drives 330 storing data, and controls the memory device 300. For example, as described above, the disk controller 140 writes and reads data to and from the physical disk drive 330 according to the data I/O request that the channel controller 110 received from the host computer 200. Each of the disk controllers 140 is connected, together with the management terminal 160, with the internal LAN 151, and is capable of engaging in mutual communication. As a result, a micro program or the like to be executed by the disk controller 140 can be transmitted and installed from the management terminal 160.

Incidentally, two or more of the hardware devices among the foregoing channel controller 110, disk controller 140, connecting unit 150, shared memory 120 and cache memory 130 may be configured integrally.

The management terminal 160 is a computer for managing the storage subsystem 800. The system administrator, by operating the management terminal 160, for example, is able to set the configuration of the physical disk drive 330, set the path between the host computer 200 and the channel controller 110, install a micro program to the executed by the channel controller 110 or disk controller 140, or perform other operations. Here, to set the configuration of the physical disk drive 330, for instance, means the expansion or reduction of the physical disk drive 330, or the change in the RAID configuration (e.g., change from RAID 1 to RAID 5). Further, the system administrator is also able to use the management terminal 160 to perform operations of confirming the operating state of the storage subsystem 800, specifying the site of malfunction, and installing the operating system to be executed with the channel controller 110. These various settings and control may be conducted via the user interface of the management terminal 160.

The management terminal 160 may be built into the disk controller 100, or may be configured externally. Further, the management terminal 160 may also be a computer prepared for exclusively managing the disk controller 100 and memory device 300, or a versatile computer loaded with the management function of the storage subsystem 800.

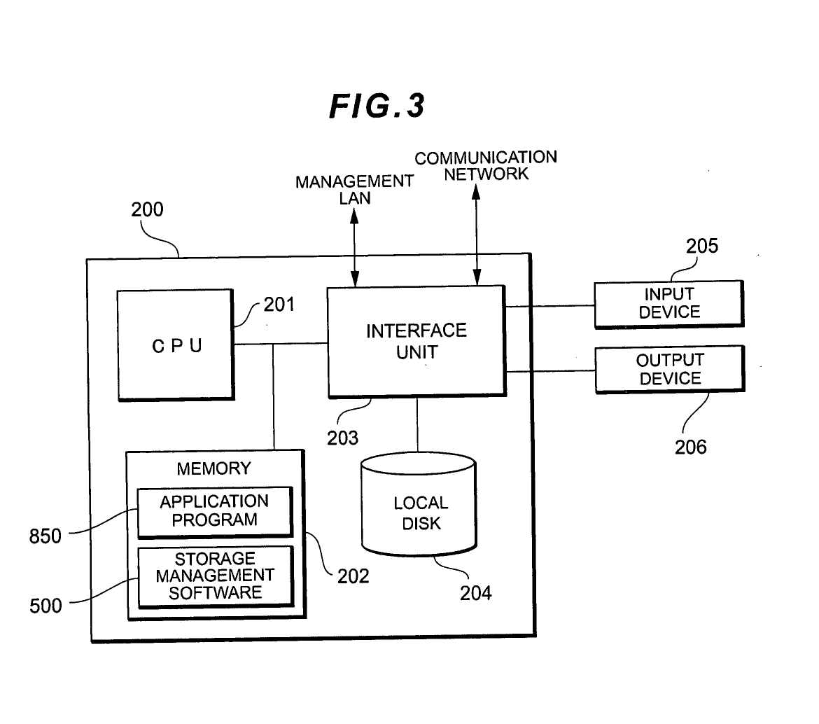

FIG. 3 is a diagram showing the system configuration of the host computer 200. The host computer 200 is configured from a CPU 201, a memory 202, an interface unit 203, a local disk 204, an input device 205 and an output device 206. A business application program 850 and storage management software 500 are stored in the memory 202. The CPU 201 performs processing of ATMs of banks based on the application program 850 stored in the memory 202, and also manages the storage subsystem 800, communication network 170 or other network components based on the storage management software 500 stored in the memory 202. The interface unit 203 is equipped with a communication interface of the management LAN 410, and a communication interface to be connected to the communication network 170. The local disk 204 stores information required upon the host computer 200 performing services, and various types of information required upon managing the storage subsystem 800. The input device 205, for instance, is a keyboard, mouse or the like. The output device 206, for instance, is a display, printer or the like.

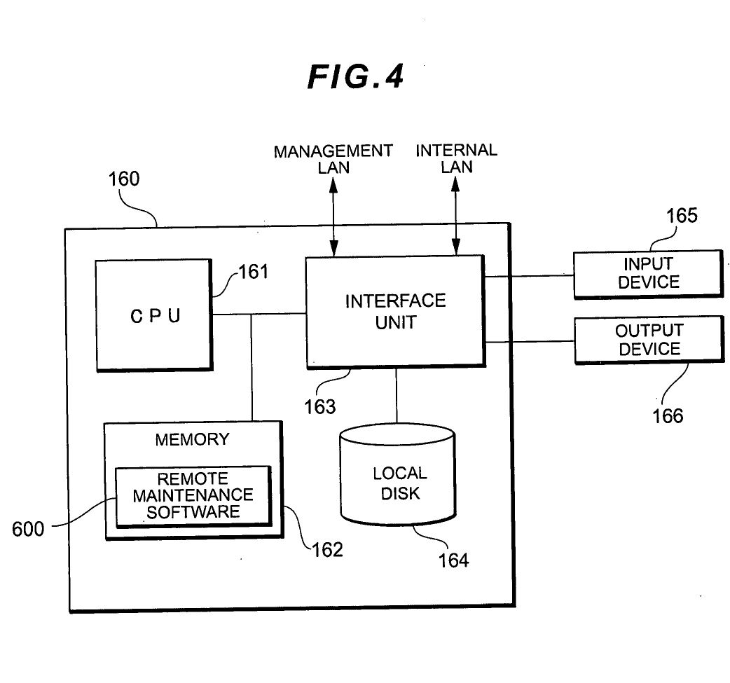

FIG. 4 is a diagram showing the system configuration of the management terminal 160. The management terminal 160 is configured from a CPU 161, a memory 162, an interface unit 163, a local disk 164, an input device 165 and an output device 166. The CPU 161 performs remote maintenance of the storage subsystem 800 based on the remote maintenance software 600 stored in the memory 162. Details regarding the remote maintenance to be performed by the management terminal 160 will be described later. The interface unit 163 is equipped with a communication interface of a management LAN 410 and an internal LAN 151, and has a function for receiving various management commands issued from the management server 700 via the management LAN 410, and a function for accessing the configuration information in the shared memory 120 via the internal LAN 151. The local disk 164 stores various types of information required upon managing the storage subsystem 800. The input device 165, for instance, is a keyboard, mouse or the like. The system administrator performs input operations to the input device 165 so as to management the storage subsystem 800. The output device 166, for instance, is a display, printer or the like.

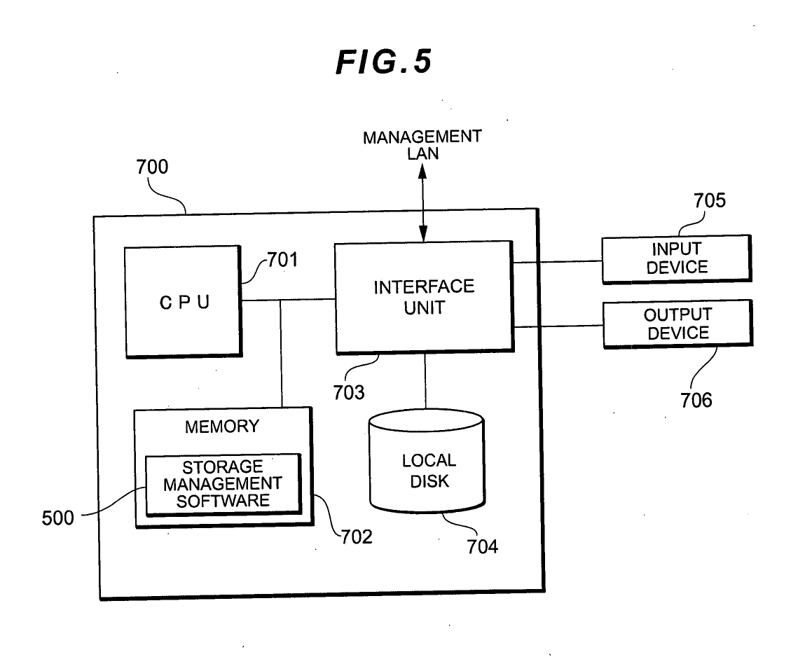

FIG. 5 is a diagram showing the system configuration of the management server 700. The management server 700 is configured from a CPU 701, a memory 702, an interface unit 703, a local disk 704, an input device 705 and an output device 706. The CPU 701 manages the storage subsystem 800 and communication network 170 based on the storage management software 500 stored in the memory 702. The interface unit 703 is equipped with a communication interface of the management LAN 410, and is capable of transmitting various management commands to the management terminal 160 via the management LAN 410. The local disk 704 stores various types of information required upon managing the storage subsystem 800. The input device 705, for instance, is a keyboard, mouse or the like. The output device 706, for instance, is a display, printer or the like.

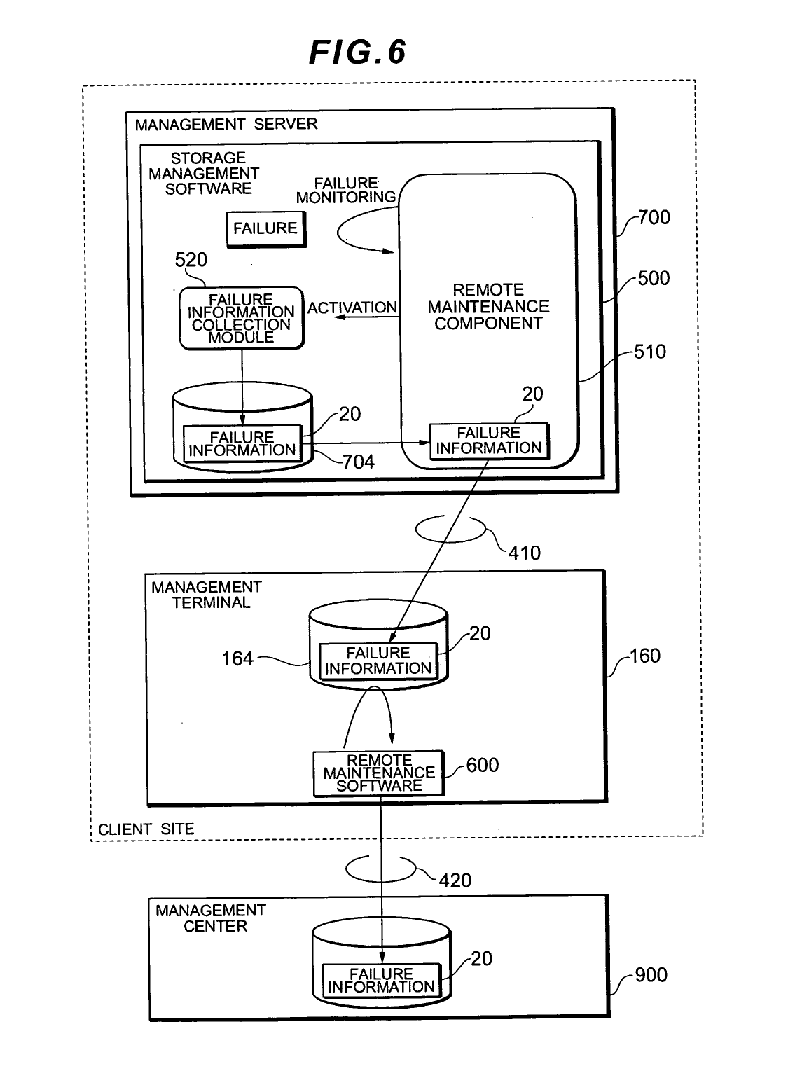

FIG. 6 is a diagram showing the outline of the failure monitoring and the failure information collection processing in the management server 700. The storage management software 500 is equipped with a remote maintenance component 510 as a module for performing remote maintenance of the storage subsystem 800, communication network 170 or other network components. The remote maintenance component 510 monitors the occurrence of failures of the storage subsystem 800, communication network 170 or other network components. As failures of the storage subsystem 800, for example, there is a failure of the hardware (e.g., shared memory 120, cache memory 130, disk controller 140, physical disk drive 330 or the like) of the storage subsystem 800, failure of the access path between the host computer 200 and channel controller 110 (e.g., read/write failure, disconnection of the fibre channel, failure of the host bus connecting unit, failure of the network component (switch or hub), among others), error in the setting or change of the configuration information (e.g., various tables to be used in disk control) of the storage subsystem 800, and so on. As failures of the storage management software 500 itself, for example, there is an internal error of the storage management software 500, communication error between the manager 500M and agent 500A described later, communication error between the storage management software 500 and storage subsystem 800, failure of commands (failure of backup, failure of change in configuration), and so on.

When the remote maintenance component 510 detects the occurrence of a failure, it activates a failure information collection module 520, collects failure information 20, and stores this in the local disk 704. As the failure information 20, there is no particular limitation so as long as it is information to be used in the failure analysis and, for example, may be log information, or information that has been encoded in advance for each type of failure. As the timing of collecting failure information 20, it is desirable to employ a timing in which the logs do not lap so that the failure information 20 will not run short. As the destination of storing the failure information 20, for example, the memory 702 may be used. The remote maintenance component 510 stores the failure information 20 in a specific directory of the local disk 164 of the management terminal 160 via the management LAN 410. When there is a plurality of management terminals 160, the failure information 20 may be written in the local disk 164 of a predetermined management terminal 160, or the failure information 20 may be written in the local disk 164 of the management terminal 160 selected at the point of transmitting such failure information 20 to the management LAN 410. Since there are many cases where the remote maintenance line 420 has small bandwidth, when the data volume of failure information 20 is large, it is desirable to extract and transmit only the portion required for the failure analysis. The remote maintenance software 600 monitors the foregoing specific directory in prescribed intervals, and detects the occurrence of a failure with the writing of failure information into such specific directory as the turning point. Then, the remote maintenance software 600 transmits the failure information 20 to the management center 900 via the remote maintenance line 420. At the management center 900, failure analysis is conducted based on the failure information 20, and necessary measures are taken such as dispatching a support engineer to the local site as necessary.

Incidentally, the storage management software 500, in addition to the foregoing failure information collection function, for instance, has a function of managing whether an expected performance (e.g., read/write performance) is being exhibited between the host computer 200 and storage subsystem 800, a function of managing the operational performance (e.g., memory usage of the storage management software 500) when the storage subsystem 800 is operated with the storage management software 500, a function of managing whether the configuration of the storage subsystem 800 is configured as recommended (e.g., setting of pair volumes, disk capacity), or the like.

Further, with respect to the failure monitoring and failure information collection processing in the host computer 200, these are similar to the failure management and failure information collection processing in the management server 700 described above.

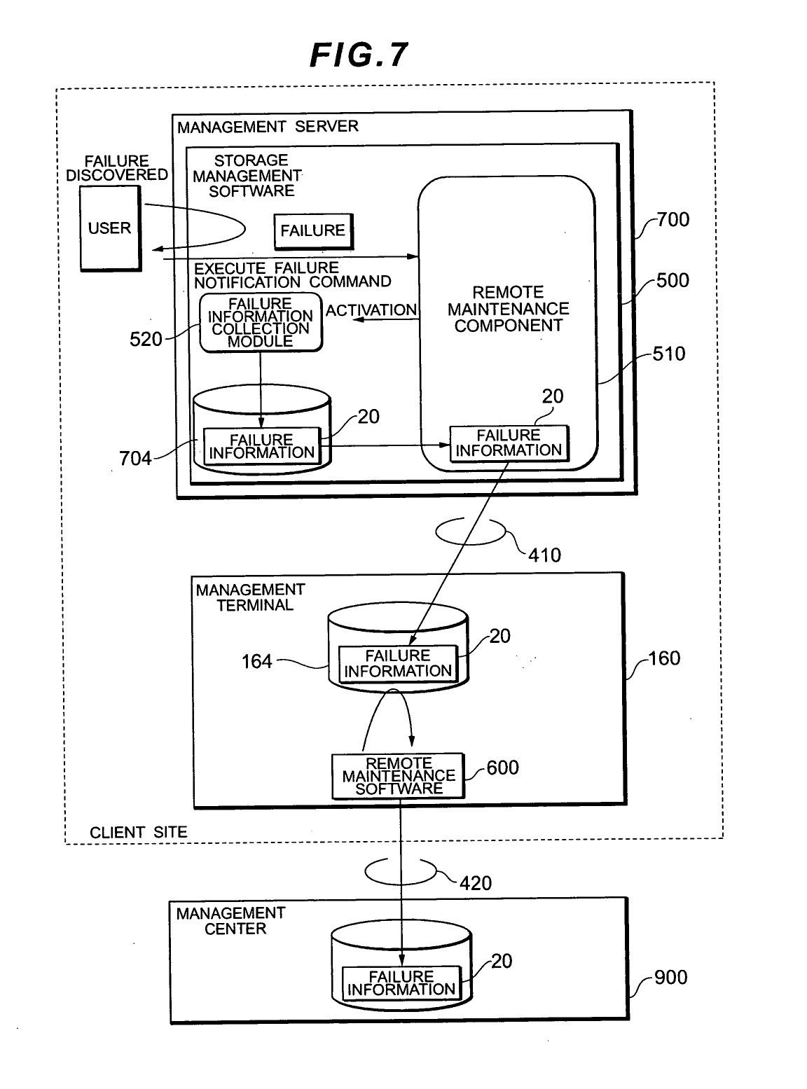

FIG. 7 is a diagram showing the outline of another example of the failure information collection processing in the management server 700. Although the remote maintenance component 510 was performing the failure monitoring with the foregoing failure information collection processing (FIG. 6), in this example, as a result of the user discovering a failure and inputting a failure notification command in the management server 700, the remote maintenance component 510 activates the failure information collection module 520 and collects the failure information 20. In the present invention, the turning point of collecting failure information may be the detection of the occurrence of a failure by the remote maintenance component 510, or the discovery of the occurrence of a failure by a user. Since the other processing steps after the occurrence of a failure is detected are the same as with the foregoing failure information collection processing (FIG. 6), the detailed explanation thereof is omitted.

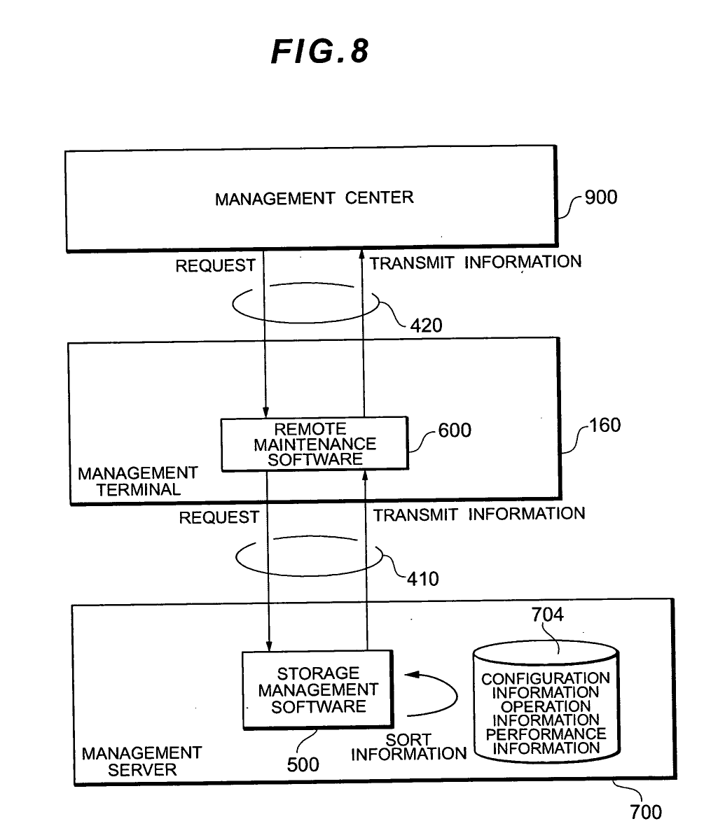

FIG. 8 is a diagram showing the outline of the processing of the storage management software transmitting various types of information that it manages (configuration information, operation information, performance information or the like) to the management center 900 according to the request from the management center 900. The storage management software 500 manages various types of information such as configuration information, operation information, performance information and so on of the storage subsystem 800, host computer 200, communication network 170 or other network components (switch, hub, or the like). Such information, for example, may be stored in the local disk 704, and necessary information may be transmitted to the management center 900 according to the request from the management center 900. In order to extract such information stored in the local disk 704, the management center 900 foremost logs onto the management terminal 160 via the remote maintenance line 420, and requests the transmission of information. Then, the management terminal 160 (specifically, the remote maintenance software 600) accesses the management server 700 via the management LAN 410, and requests the acquisition of information requested from the management server 900. Then, the management server 700 (specifically, the storage management software 500) sorts information requested from the management center 900 among the various types of information stored in the local disk 704, and transmits this to the management terminal 160 via the management LAN 410. The management terminal 160 forwards the information received from the management server 700 to the management center 900 via the maintenance line 420.

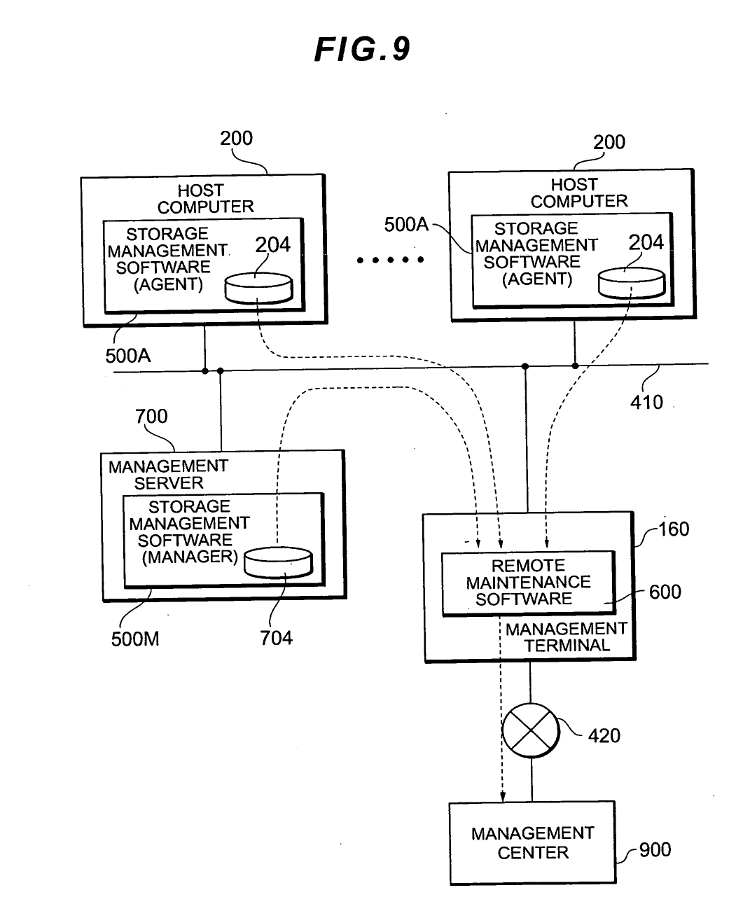

Next, the push-type failure information collection processing and pull-type failure information collection processing are additionally explained with reference to FIG. 9 to FIG. 13. The foregoing storage management software 500 can be classified into an agent 500A and a manager 500M. The agent 500A, for instance, is installed in the host computer 200. The agent 500A, in addition to monitoring the failure of the host computer 200 and collecting failure information, it also monitors the failure of the storage subsystem 800 and collects failure information via the communication network 170. The agent 500A transmits the collected failure information to the manager 500M. Meanwhile, the manager 500M, for instance, is installed in the management server 700. By communicating with the agent 500A loaded onto the host computer 200, the manager 500M monitors the failure of the host computer 200 and collects failure information, as well as monitors the failure the storage subsystem 800 and collects information via the management LAN 410. The manager 500M consolidates the failure information of the plurality of host computers 200 and storage subsystem 800, and unifies the management thereof.

FIG. 9 is a diagram showing the outline of the push-type failure information collection processing. When each of the agents 500A installed in the respective host computers 200 detects the occurrence of a failure, after temporarily storing the failure information in the local disk 204, it individually transmits the failure information to the management terminal 160 via the management LAN 410, and performs write processing of failure information in a specific directory of the management terminal 160. When the manager 500M installed in the management server 700 detects the occurrence of a failure, after temporarily storing the failure information in the local disk 704, it transmits the failure information to the management terminal 160 via the management LAN 410, and performs write processing of failure information in a specific directory of the management terminal 160 independently from the respective agents 500A. When there is a plurality of management terminals 160, each of the agents 500A and manager 500M may select the management terminal 160 to which the failure information is to be sent on a case-by-case basis, or transmit the failure information to a predetermined management terminal 160. When the remote maintenance software 600 detects the writing of failure information in a specific directory of the management terminal 160, it transmits failure information to the management center 900 via the remote maintenance line 420 on a case-by-case basis.

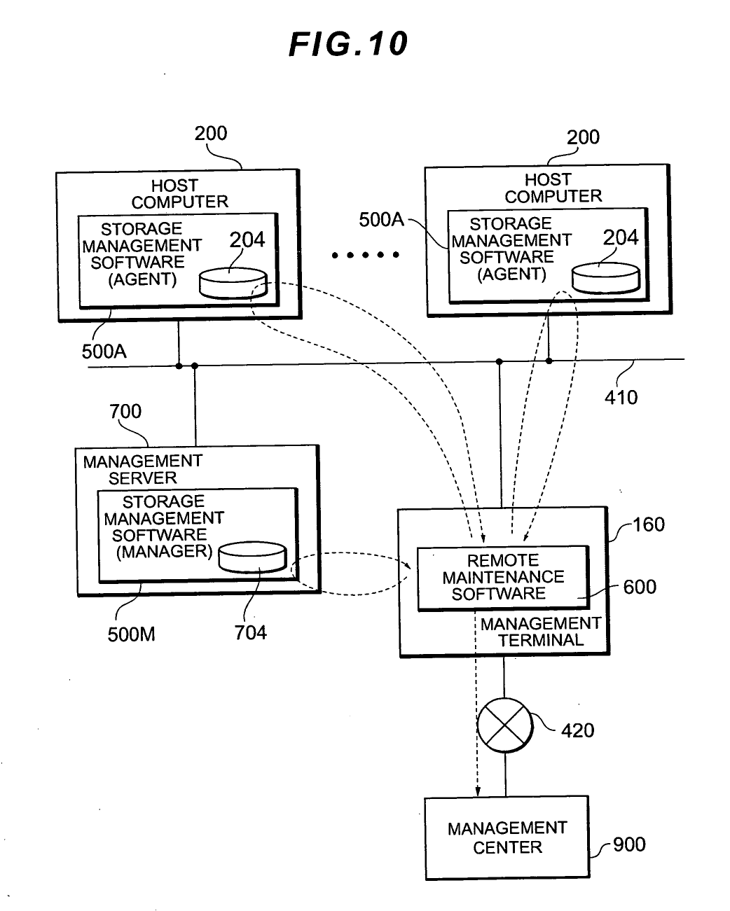

FIG. 10 is a diagram showing the outline of the pull-type failure information collection processing. When each of the agents 500A installed in the respective host computers 200 detects the occurrence of a failure, it temporarily stores the failure information in the local disk 204. Similarly, when the manager 500M installed in the management server 700 detects the occurrence of a failure, it temporarily stores the failure information in the local disk 704. As the destination for storing the failure information, for instance, a specific directory of the local disks 204, 704 is preferably used. The remote maintenance software 600 installed in the management terminal 160 periodically accesses a specific directory of the local disks 204, 704 via the management LAN 410, and, when the remote maintenance software 600 detects the update of the failure information stored in such directory, it acquires the latest failure information, and transmits this to the management center 900.

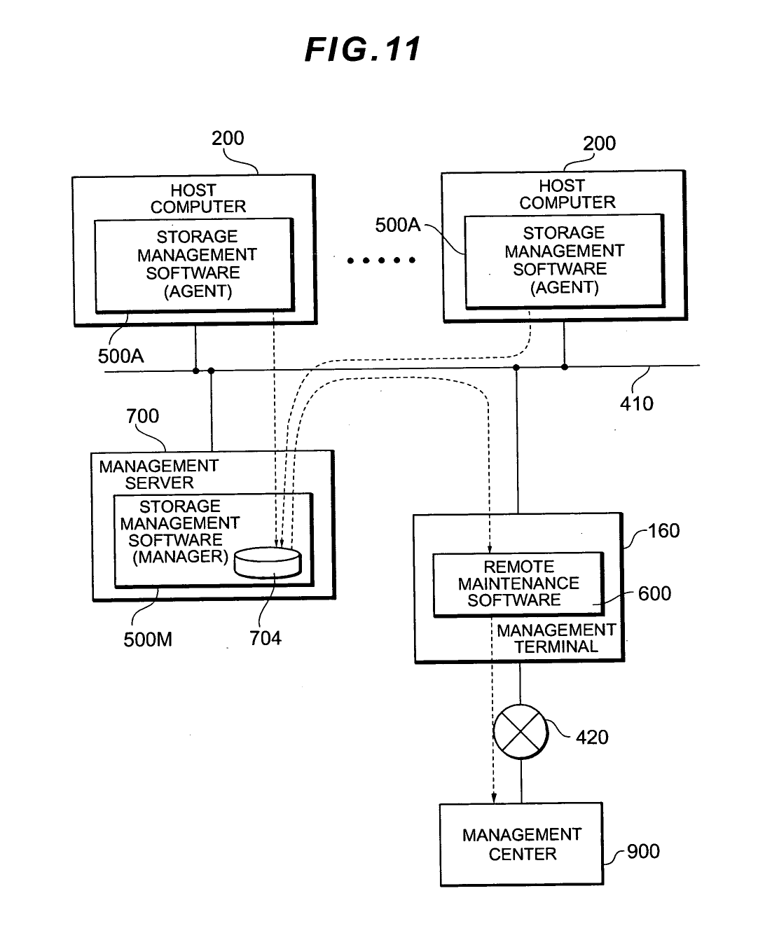

FIG. 11 is a diagram showing the outline of the push-type failure information collection processing. What is different from the push-type processing illustrated in FIG. 9 is that the failure information acquired by each of the agents 500A is once consolidated by the manager 500M, and then managed uniformly. The manager 500M not only manages the failure information that it detected, it also manages the failure information detected by each of the agents 500A. When the manager 500M acquires the failure information from each of the agents 500A, it writes the failure information in a specific directory of the management terminal 160 via the management LAN 410. When the remote maintenance software 600 detects the writing of failure information in a specific directory of the management terminal 160, it transmits the failure information to the management center 900 via the remote maintenance line 420 on a case-by-case basis.

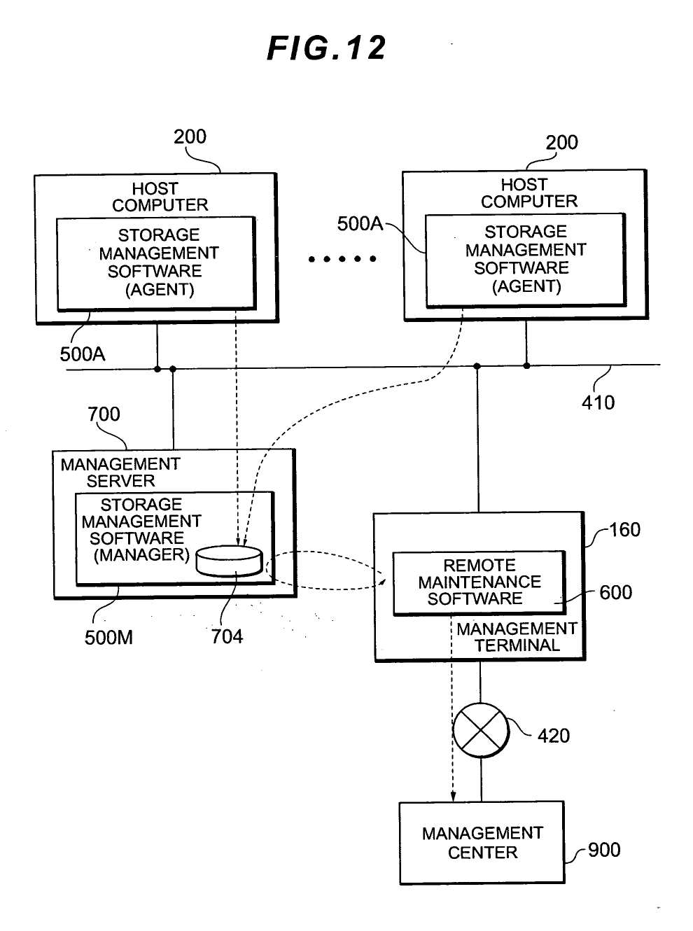

FIG. 12 is a diagram showing the outline of the pull-type failure information collection processing. What is different from the pull-type processing illustrated in FIG. 10 is that the failure information acquired by each of the agents 500A is once consolidated by the manager 500M, and then managed uniformly. The manager 500M not only stores the failure information that it detected in a specific directory of the local disk 704, it also stores the failure information detected by each of the agents 500A in a specific directory of the local disk 704, and manages this uniformly. When the remote maintenance software 600 installed in the management terminal 160 periodically accesses a specific directory of the local disk 704 via the management LAN 410 and detects the update of failure information stored in such directory, it acquires the latest failure information and transmits this to the management center 900.

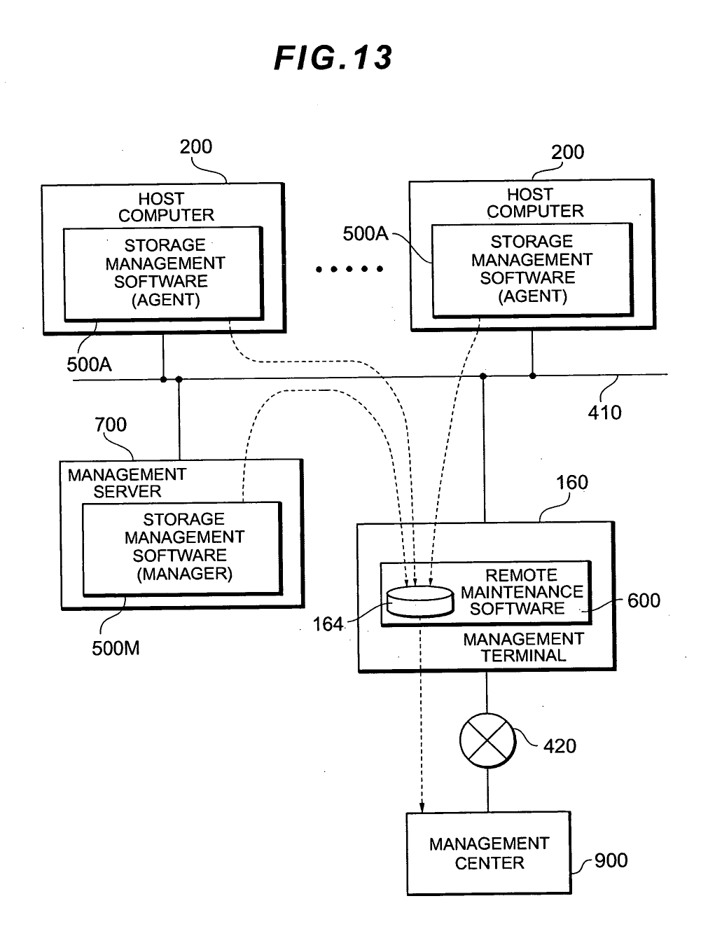

FIG. 13 is a diagram showing the outline of the push-type failure information collection processing. What is different from the push-type processing illustrated in FIG. 9 is that the failure information detected by each of the agents 500A and the manager 500M is directly stored in a specific directory of the local disk 164 of the management terminal 160. When the management terminal 160 uniformly manages the failure information detected by each of the agents 500A and the manager 500M detects the update of failure information stored in a specific directory of the local disk 164, it acquires the latest failure information and transmits this to the management center 900 via the remote maintenance line 420.

We claim:

1. A method for managing administrative information of a storage network in which a host computer or a management server is connected, via a management communication line, to a management terminal that manages a storage subsystem and which is connected to a management center via a remote maintenance line, the method comprising the steps of:
transmitting the administrative information of said host computer or said management server to said management terminal via said management communication line; and
transmitting the administrative information acquired by said management terminal from said host computer or said management server to said management center via said remote maintenance line.

2. The method according to claim 1, wherein said management server consolidates the administrative information of a plurality of said host computers and transmits said administrative information to said management terminal via said management communication line.

3. A storage management system, comprising:
a management terminal for managing a storage subsystem and which is connected to a management center via a remote maintenance line;
a host computer for using a storage resource provided from said storage subsystem;
a management server for managing said storage subsystem; and
a management communication line for connecting said host computer, said management server and said management terminal;
wherein said host computer or said management server transmits administrative information to said management terminal via said management communication line, and said management terminal transmits the administrative information received from said host computer or said management server to said management center via said remote maintenance line.

4. The storage management system according to claim 3, wherein said management server consolidates the administrative information of a plurality of said host computers and transmits said administrative information to said management terminal via said management communication line.

5. A computer program product having a storage management software to be loaded onto a host computer or a management server connected, via a management communication line, to a management terminal that manages a storage subsystem and which is connected to a management center via a remote maintenance line,
wherein said storage management software causes said host computer or said management server execute a step of transmitting administrative information of said host computer or said management server to said management terminal via said management communication line.

6. The computer program product according to claim 5, wherein said storage management software further causes said management server execute a step of consolidating the administrative information of a plurality of host computers and transmitting said administrative information to said management terminal via said management communication line.
